(19) United States
(12) Patent Application Publication
(10) Pub. No.: US 2013/0264970 A1
(43) Pub. Date: Oct. 10, 2013

(54) LIGHT EMITTING DIODE (LED) COMPONENTS AND METHODS FOR IMPROVED LIGHT EXTRACTION

(71) Applicants: Yew Cheong Kuan, (US); Craige William Hardin, (US); Man Ngok Chu, (US); Thye Linn Mok, (US); Yung-Ching Hu, (US); Hsien-Ming Wang, (US); Heng-Yen Lee, (US)

(72) Inventors: Yew Cheong Kuan, (US); Craige William Hardin, (US); Man Ngok Chu, (US); Thye Linn Mok, (US); Yung-Ching Hu, (US); Hsien-Ming Wang, (US); Heng-Yen Lee, (US)

(21) Appl. No.: 13/441,025

(22) Filed: Apr. 6, 2012

(51) Int. Cl. H05B 33/02; H05B 33/10

(52) U.S. Cl. 315/312; 313/111; 445/23

(57) ABSTRACT

Light emitter components with improved light extraction and related methods are disclosed. In one embodiment, the light emitter component can include a submount, at least one light emitting chip disposed over the submount, and a lens disposed over a portion of the light emitting chip. The lens can include an optical element. The optical element can be configured to affect light output from the at least one light emitting chip.

### TECHNICAL FIELD

The subject matter disclosed herein relates generally to light emitting diode (LED) components and methods. More particularly, the subject matter disclosed herein relates to LED components and methods for improved light extraction.

### BACKGROUND

Light emitting diodes (LEDs) or LED chips are solid state devices that convert electrical energy into light. LED chips can be utilized in light emitter components for providing different colors and patterns of light useful in various lighting applications. For example, light emitter components can be used in various LED light bulb and light fixture applications and are developing as replacements for incandescent, fluorescent, and metal halide high-intensity discharge (HID) lighting applications.

Conventional light emitter components used in light bulb and fixture applications incorporate either (i) discrete LED packages (e.g., packaged LED chips) positioned in an array over a substrate or (ii) closely packed arrays of LED chips positioned over a substrate and encapsulated under a single lens. Problems associated with the first approach include both an increased time and cost associated with individually packaging LED chips prior to assembly onto a substrate. The second approach, which utilizes closely packed arrays of LED chips, is susceptible to light extraction problems as adjacent LED chips and/or wirebonds associated with adjacent LED chips can block light. In addition, extracting a correct or desired beam pattern from a closely packed array of LED chips can be difficult using a single lens. Another drawback associated with conventional components is that although non-round or square shaped arrays can be preferred or desired in many applications and during manufacture, non-round or square shaped arrays of LED chips produce non-round or square beam patterns which are not optimized for light bulb applications. Accordingly, minimizing time consuming and costly steps associated with discrete LED packages as well as improving light extraction and light beam patterns from light emitter components is becoming more important for maintaining or exceeding expected cost and optical properties expected and required from a given component.

Despite the availability of various light emitter components in the marketplace, a need remains for components and methods having improved efficiency and light extraction. A need also remains for components and methods of obtaining simplified beam pattern shaping and obtaining desired beam patterns from LED chips.

### SUMMARY

In accordance with this disclosure, light emitter components and methods are provided and described herein for producing a desired beam pattern. Components and methods described herein can exhibit improved light extraction and be well suited for a variety of applications such as personal, industrial, and commercial lighting applications including, for example, light bulbs and light fixture products and/or applications. It is, therefore, an object of the present disclosure to provide light emitter components and methods which improve light extraction, in one aspect, by extracting light from individual LED chips via individually positioned optical domes while at the same time producing a beam pattern in a desired shape from an array of LED chips configured in a configuration that is different from the desired beam pattern.

These and other objects of the present disclosure as can become apparent from the disclosure herein are achieved, at least in whole or in part, by the subject matter disclosed herein.

### BRIEF DESCRIPTION OF THE DRAWINGS

A full and enabling disclosure of the present subject matter including the best mode thereof to one of ordinary skill in the art is set forth more particularly in the remainder of the specification, including reference to the accompanying figures, in which:

FIG. 1 is a top view of an embodiment of a light emitter component according to the disclosure herein;

FIGS. 2A and 2B are top perspective views of emitter components according to the disclosure herein;

FIG. 3 is a side view of the emitter component according to the disclosure herein;

FIGS. 4A to 4H are schematic diagrams of light emitter components according to the disclosure herein;

FIGS. 5A and 5B are cross-sectional views of portions of light emitter components according to the disclosure herein;

FIGS. 6A to 6C are side views of LED chips within a light emitter component according to the disclosure herein;

FIG. 7 is a schematic diagram of a light emitter component according to the disclosure herein; and

FIGS. 8A and 8B are perspective views of lighting products which can incorporate light emitter components according to the disclosure herein.

### DETAILED DESCRIPTION

The subject matter disclosed herein is directed to light emitting diode (LED) components and methods for improved light extraction including, for example, a light beam pattern that can be in a shape that is different than a shape or configuration of an array of LED chips emitting the light. An optical dome and one or more optical elements can be used to create the desired shape of beam pattern from a differently shaped array or arrangement of LED chips. Reference will be made in detail to possible aspects or embodiments of the subject matter herein, one or more examples of which are shown in the figures. Each example is provided to explain the subject matter and not as a limitation. In fact, features illustrated or described as part of one embodiment can be used in another embodiment to yield still a further embodiment. It is intended that the subject matter disclosed and envisioned herein covers such modifications and variations.

As illustrated in the various figures, some sizes of structures or portions are exaggerated relative to other structures or portions for illustrative purposes and, thus, are provided to illustrate the general structures of the present subject matter. Furthermore, various aspects of the present subject matter are described with reference to a structure or a portion being formed on other structures, portions, or both. As will be appreciated by those of skill in the art, references to a structure being formed “on” or “above” another structure or portion contemplates that additional structure, portion, or both may intervene. References to a structure or a portion being formed “on” another structure or portion without an intervening structure or portion are described herein as being formed “directly on” the structure or portion. Similarly, it will be understood that when an element is referred to as being “connected”, “attached”, or “coupled” to another element, it can be directly connected, attached, or coupled to the other element, or intervening elements may be present. In contrast, when an element is referred to as being “directly connected”, “directly attached”, or “directly coupled” to another element, no intervening elements are present.

Furthermore, relative terms such as “on”, “above”, “upper”, “top”, “lower”, or “bottom” are used herein to describe one structure's or portion's relationship to another structure or portion as illustrated in the figures. It will be understood that relative terms such as “on”, “above”, “upper”, “top”, “lower” or “bottom” are intended to encompass different orientations of the component in addition to the orientation depicted in the figures. For example, if the component in the figures is turned over, structure or portion described as “above” other structures or portions would now be oriented “below” the other structures or portions. Likewise, if components in the figures are rotated along an axis, structure or portion described as “above”, other structures or portions would be oriented “next to” or “left of” the other structures or portions. Like numbers refer to like elements throughout.

Unless the absence of one or more elements is specifically recited, the terms “comprising”, including”, and “having” as used herein should be interpreted as open-ended terms that do not preclude the presence of one or more elements.

Light emitter components according to embodiments described herein can comprise group III-V nitride (e.g., gallium nitride (GaN)) based LED chips or lasers. Fabrication of LED chips and lasers is generally known and only briefly described herein. LED chips or lasers can be fabricated on a growth substrate, for example, a silicon carbide (SiC) substrate, such as those devices manufactured and sold by Cree, Inc. of Durham, N.C. Other growth substrates are also contemplated herein, for example and not limited to sapphire, silicon (Si), and GaN. In one aspect, SiC substrates/layers can be 4H polytype silicon carbide substrates/layers. Other SiC candidate polytypes, such as 3C, 6H, and 15R polytypes, however, can be used. Appropriate SiC substrates are available from Cree, Inc., of Durham, N.C., the assignee of the present subject matter, and the methods for producing such substrates are set forth in the scientific literature as well as in a number of commonly assigned U.S. patents, including but not limited to U.S. Pat. No. Re. 34,861; U.S. Pat. No. 4,946,547; and U.S. Pat. No. 5,200,022, the disclosures of which are incorporated by reference herein in their entireties. Any other suitable growth substrates are contemplated herein.

As used herein, the term “Group III nitride” refers to those semiconducting compounds formed between nitrogen and one or more elements in Group III of the periodic table, usually aluminum (Al), gallium (Ga), and indium (In). The term also refers to binary, ternary, and quaternary compounds such as GaN, AlGaN and AlInGaN. The Group III elements can combine with nitrogen to form binary (e.g., GaN), ternary (e.g., AlGaN), and quaternary (e.g., AlInGaN) compounds. These compounds may have empirical formulas in which one mole of nitrogen is combined with a total of one mole of the Group III elements. Accordingly, formulas such as AlxGa1-xN where 1>x>0 are often used to describe these compounds. Techniques for epitaxial growth of Group III nitrides have become reasonably well developed and reported in the appropriate scientific literature.

Although various embodiments of LED chips disclosed herein can comprise a growth substrate, it will be understood by those skilled in the art that the crystalline epitaxial growth substrate on which the epitaxial layers comprising an LED chip are grown can be removed, and the freestanding epitaxial layers can be mounted on a substitute carrier substrate or substrate which can have different thermal, electrical, structural and/or optical characteristics than the original substrate. The subject matter described herein is not limited to structures having crystalline epitaxial growth substrates and can be used in connection with structures in which the epitaxial layers have been removed from their original growth substrates and bonded to substitute carrier substrates.

Group III nitride based LED chips according to some embodiments of the present subject matter, for example, can be fabricated on growth substrates (e.g., Si, SiC, or sapphire substrates) to provide horizontal devices (with at least two electrical contacts on a same side of the LED chip) or vertical devices (with electrical contacts on opposing sides of the LED chip). Moreover, the growth substrate can be maintained on the LED chip after fabrication or removed (e.g., by etching, grinding, polishing, etc.). The growth substrate can be removed, for example, to reduce a thickness of the resulting LED chip and/or to reduce a forward voltage through a vertical LED chip. A horizontal device (with or without the growth substrate), for example, can be flip chip bonded (e.g., using solder) to a carrier substrate or printed circuit board (PCB), or wirebonded. A vertical device (with or without the growth substrate) can have a first terminal (e.g., anode or cathode) solder bonded to a carrier substrate, mounting pad, or PCB and a second terminal (e.g., the opposing anode or cathode) wirebonded to the carrier substrate, electrical element, or PCB. Examples of vertical and horizontal LED chip structures are discussed by way of example in U.S. Publication No. 2008/0258130 to Bergmann et al. and in U.S. Pat. No. 7,791,061 to Edmond et al. which issued on Sep. 7, 2010, the disclosures of which are hereby incorporated by reference herein in their entireties.

One or more LED chips can be at least partially coated with one or more phosphors. The phosphors can absorb a portion of light from the LED chip and emit a different wavelength of light such that the light emitter component emits a combination of light from each of the LED chip and the phosphor. In one embodiment, the light emitter component emits what is perceived as white light resulting from a combination of light emission from the LED chip and the phosphor. In one embodiment according to the present subject matter, white emitting components can consist of an LED chip that emits light in the blue wavelength spectrum and a phosphor that absorbs some of the blue light and re-emits light in the yellow wavelength spectrum. The components can therefore emit a white light combination of blue and yellow light. In other embodiments, the LED chips emit a non-white light combination of blue and yellow light as described in U.S. Pat. No. 7,213,940. LED chips emitting red light or LED chips covered by a phosphor that absorbs LED light and emits a red light are also contemplated herein.

LED chips can be coated with a phosphor using many different methods, with one suitable method being described in U.S. patent application Ser. Nos. 11/656,759 and 11/899,790, both entitled “Wafer Level Phosphor Coating Method and Devices Fabricated Utilizing Method”, and both of which are incorporated herein by reference in their entireties. Other suitable methods for coating one or more LED chips are described in U.S. Pat. No. 8,058,088 entitled “Phosphor Coating Systems and Methods for Light Emitting Structures and Packaged Light Emitting Diodes Including Phosphor Coating” which issued on Nov. 15, 2011, and the continuation-in-part application U.S. patent application Ser. No. 12/717,048 entitled “Systems and Methods for Application of Optical Materials to Optical Elements”, the disclosures of which are hereby incorporated by reference herein in their entireties. LED chips can also be coated using other methods such as electrophoretic deposition (EPD), with a suitable EPD method described in U.S. patent application Ser. No. 11/473,089 entitled “Close Loop Electrophoretic Deposition of Semiconductor Devices”, which is also incorporated herein by reference in its entirety. It is understood that light emitter components and methods according to the present subject matter can also have multiple LED chips of different colors, one or more of which can be white emitting.

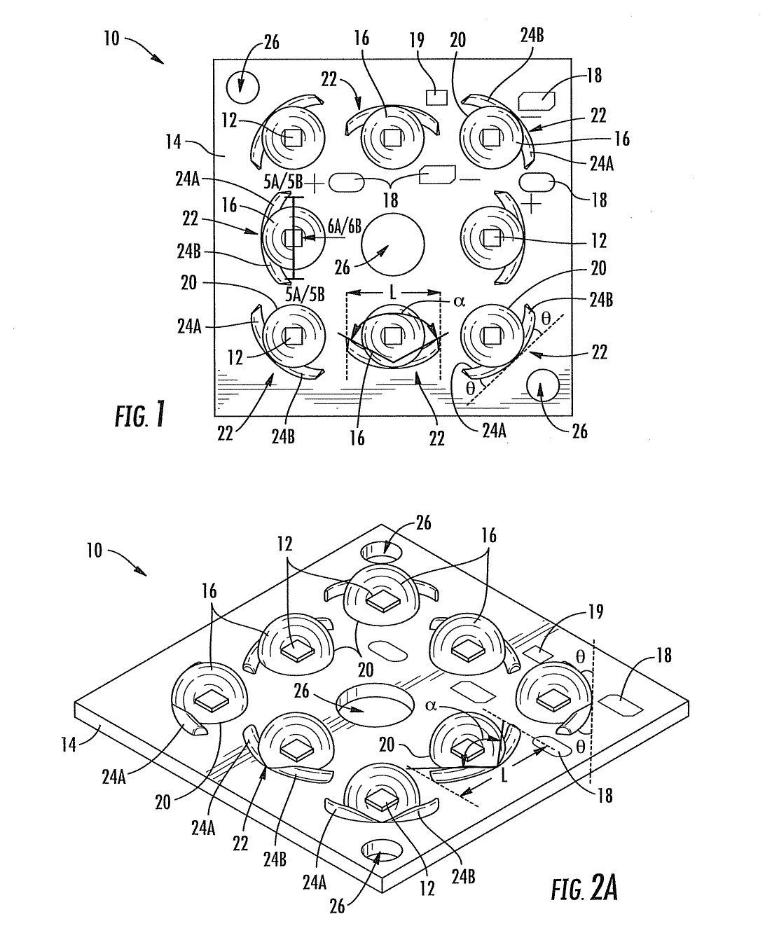

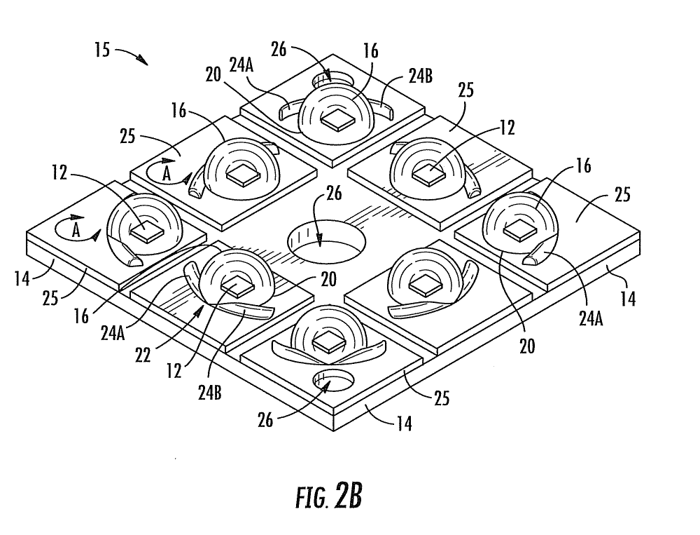

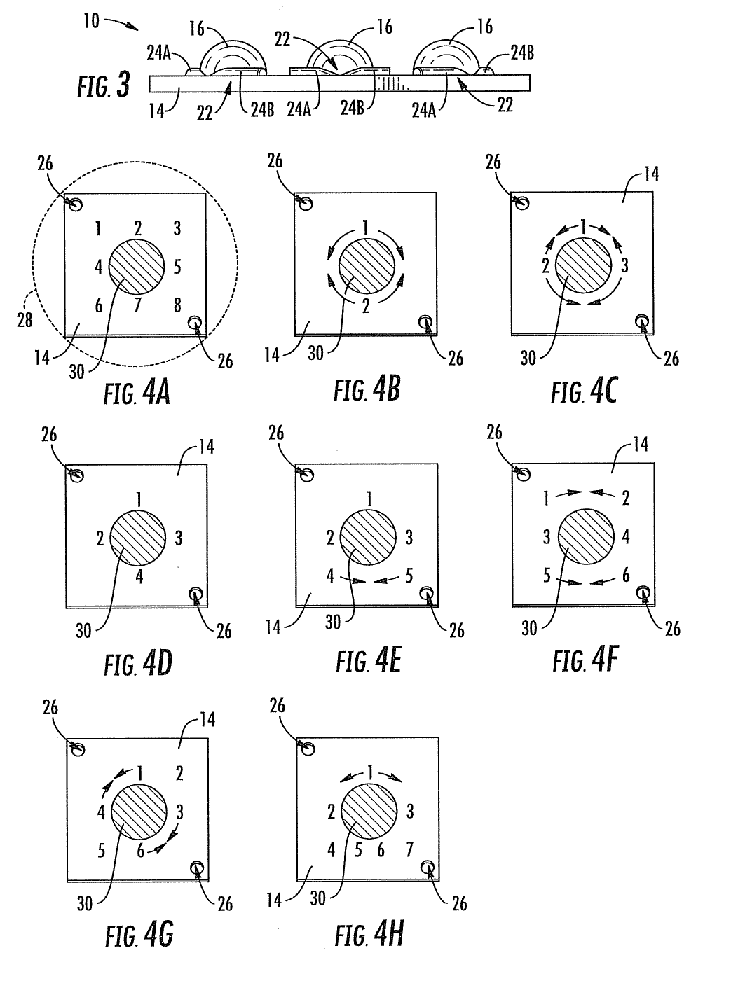

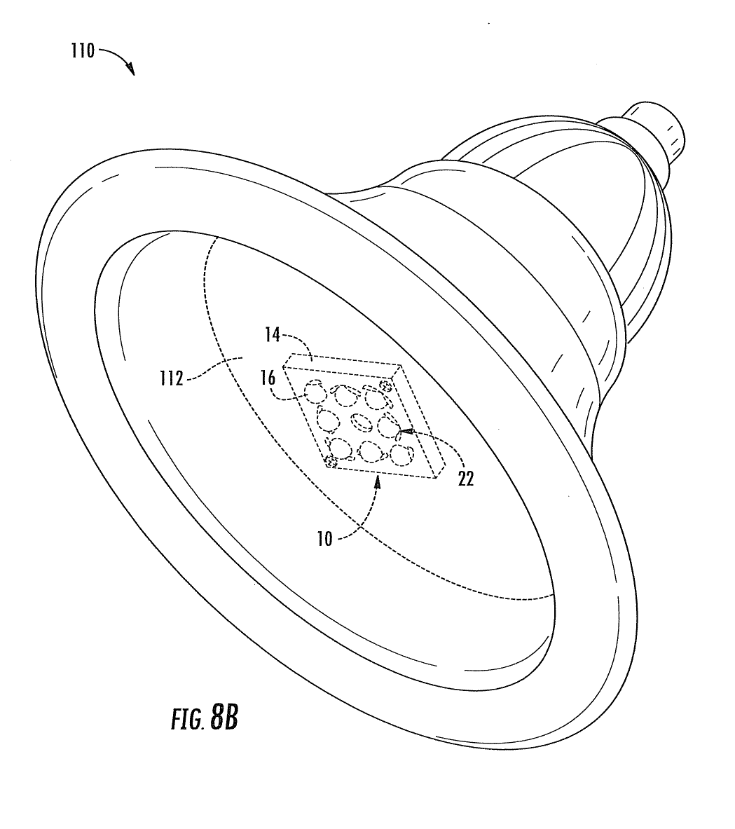

FIGS. 1 through 7 illustrate embodiments of light emitter components and methods according to the present subject matter as disclosed and described herein. FIGS. 8A and 8B illustrate lighting products, including, but not limited to light bulbs and lighting fixtures (e.g., downlights, “can” lights, etc.) which can incorporate light emitter components according to the present subject matter. FIG. 1 is a top view of a light emitter component, generally designated 10. FIGS. 2A and 2B are top perspective views of embodiments of emitter components, and FIG. 3 is a side view of an emitter component. FIG. 2B is a different embodiment of a light emitter component, generally designated 15. One difference between emitter components 10 and 15 is the introduction of one or more intermediate submounts 25 disposed between one or more LED chips 12 and a substrate or submount 14. Light emitter components 10 and 15 can comprise at least one solid state emitter, such as an LED chip 12. Light emitter components 10 and 15 can comprise more than one LED chip, for example, two, three, or more than three LED chips 12 such as the LED chips described herein. In one aspect, an array of LED chips 12 can be arranged over a substrate or submount 14 in a chip on board (CoB) structure. CoB structures are described in, for example, U.S. Pat. No. 7,821,023 to Yuan et al., which issued on Oct. 26, 2010, and U.S. Patent Application no. 2009/0108281 to Keller et al., published on Apr. 30, 2009, both of which are commonly assigned and hereby incorporated by reference in their entireties.

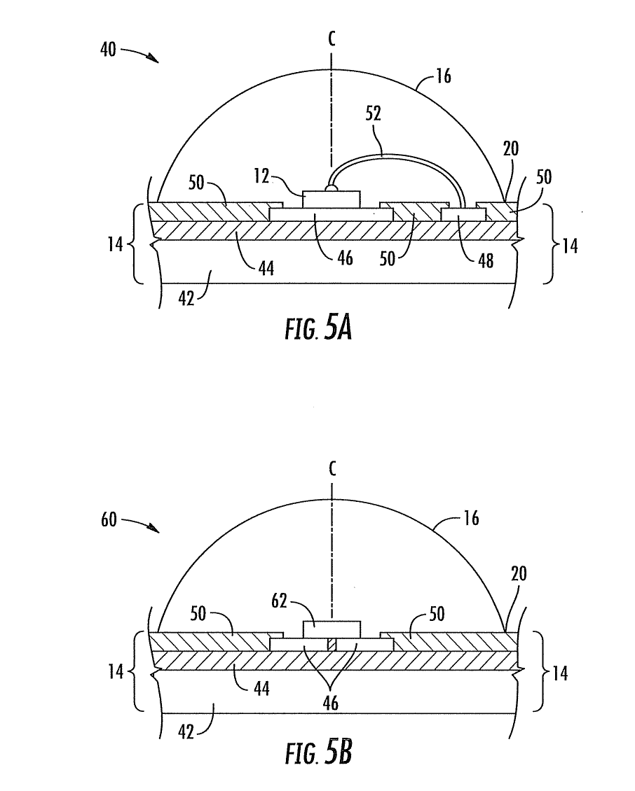

LED chips 12 can be arranged in arrays and/or subarrays. A lens 16 can overlie at least one of the LED chips 12 in the array or subarray. The arrays and/or subarrays described herein can include any number of LED chips 12 in order to provide the desired light output from light emitter components 10 and 15. For example, light emitter components 10 and 15 can comprise an LED array comprising at least four LED chips, at least five LED chips, at least six LED chips, at least seven LED chips, at least eight LED chips, at least nine LED chips, at least 10 LED chips, at least 12 LED chips, or at least 20 LED chips (see e.g., FIGS. 4A to 4H). Smaller arrays are also possible as described previously, or larger arrays are also possible as, for example, light emitter components 10 and 15 could also comprise an array of at least 30, 40, or 50 or more LED chips 12. For illustration purposes, only eight LED chips 12 are shown in FIGS. 1 to 3.

LED chip 12 can comprise any suitable chip dimension and/or shape such as substantially square or rectangular in shape. In one aspect, LED chip 12 can comprise a square chip having sides approximately equal to 1000 μm or less (e.g., 1000×1000 μm²) or of any larger size. LED chip 12 can comprise a substantially square chip with sides of any range or sub-range less than approximately 1000 μm, for example, an approximately 900×900 μm² chip; an approximately 700×700 μm² chip; an approximately 600×600 μm² chip; an approximately 500×500 μm² chip; an approximately 400×400 μm² chip; an approximately 300×300 μm² chip; an approximately 200×200 μm² chip; or an approximately 100×100 μm² chip. Multiple LED chips 12 can be utilized in light emitter components 10 and 15. In one aspect, each LED chip 12 can be the same size. In other aspects, one or more LED chips 12 can consist of different sizes. LED chips 12 can also comprise rectangular chips of any suitable dimension.

LED chips 12 as described herein can embody a solid state emitter used alone and/or in combination with phosphors or lumiphors to emit light of various colors, color points, or wavelength ranges, such as light that is primarily white, blue, cyan, green, yellow, amber, or red. In one aspect light emitter components 10 and 15 can comprise one or more LED chips 12 that are primarily blue, which when illuminated, can activate a yellow phosphor disposed over the LED chip 12 (e.g., phosphor can be at least partially directly disposed over LED chip 12 and/or on a portion of light emitter components 10 and 15 that is disposed over LED chip 12, for example, such as lens 16) such that LED chip 12 comprises a blue shifted yellow (BSY) chip. In alternative embodiments, a primarily red LED chip 12 can be included in emitter components described herein and can be used alone and/or combination with a BSY chip. In one aspect, a red LED chip 12 can also optionally be disposed below a phosphor, encapsulant, and/or lens 16 with a phosphor layer for mixing to produce warm white output. Light emitter components 10 and 15 can comprise at least one LED chip 12 configured to activate a yellow, red, and/or green phosphor either disposed directly over LED chip 12 and/or directly over a portion of emitter component, such as for example, yellow, red or green phosphor can be disposed on or in a portion of lens 16 for producing cool and/or warm white output. In yet a further embodiment, components 10 and 15 can comprise more than one LED chip 12 such as a plurality and/or array of LED chips 12. Each chip in the plurality or array of LED chips 12 can comprise approximately the same wavelength (e.g., selected from the same targeted wavelength bin). In the alternative, at least a first LED chip 12 of the plurality of LED chips can comprise a different wavelength than at least a second LED chip of the plurality of LED chips (e.g., at least a first LED chip 12 could be selected from a different targeted wavelength bin than at least one other LED chip 12).

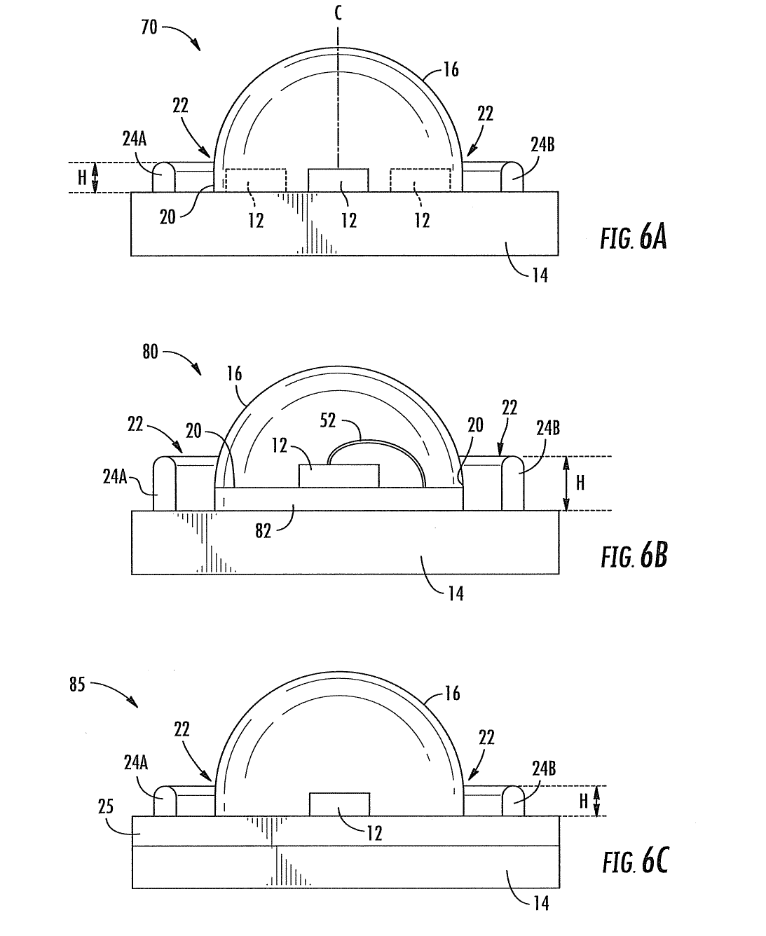

Still referring to FIGS. 1 through 3, and as described above, the one or more LED chips 12 can comprise any size, structure, build, and/or shape as desired, and can comprise any known LED chip. LED chips 12 can illuminate when electrical signal or current passes into the emitter component via any suitable attachment surfaces such as attachment surfaces 18. For example, electrical current can pass into one or more electrically conductive wires (not shown) which can electrically communicate with attachment surfaces 18 via welding, soldering, crimping, or other attachment method, to pass current into components 10 and 15. Attachment surfaces 18 can comprise positive and negative electrode terminals (i.e., an anode and cathode pair) designated by the “+” and “−” signs, respectively, and can comprise solder pads, electrical connectors, or areas of exposed electrically conductive material for electrically connecting to external power sources (not shown). In one aspect, LED chips 12 comprise a build where the bottom portion of the chip comprises an anode for electrically and/or thermally communicating with a first portion of submount 14 and where a top portion of the chip comprises a cathode bond pad for electrically communicating with a second portion of submount 14 via wirebonding (e.g., a vertical device as shown and described in FIG. 5A). In other aspects, LED chips 12 can comprise a build where one side or portion of LED chip 12 comprises both an anode and a cathode such that wirebonding may be unnecessary (e.g., a horizontal device as shown and described in FIG. 5B). A horizontal device comprising both an anode and cathode on a top surface or portion of an LED chip 12 is also contemplated herein, where the cathode and anode could each be wirebonded to a portion of submount 14 (e.g., horizontal LED chips 12 having two wirebonds are contemplated herein). Electrical current that passes and out of components 10 and 15 from attachment surfaces 18 can then pass into and out of the one or more LED chips 12 thereby causing illumination of the chips.

Submount 14 can comprise a monolithic substrate such as, for example, a printed circuit board (PCB), a metal core printed circuit board (MCPCB), an FR-4 based dielectric substrate or circuit board, a ceramic substrate, a laminate substrate, a flex circuit, an external circuit, or any other suitable submount or substrate over which lighting devices such as LED chips can mount and/or attach. For example, submount 14 can comprise a core layer 42 and a dielectric layer 44 (see FIGS. 5A and 5B). For illustration purposes, submount 14 can comprise a MCPCB, for example, those available and manufactured by The Bergquist Company of Chanhassan, Minn. Any suitable submount 14 can be used, however. Core layer 42 (FIGS. 5A and 5B) can comprise a conductive metal layer, for example copper (Cu) or aluminum (Al). Dielectric layer 44 (FIGS. 5A and 5B) can comprise an electrically insulating but thermally conductive material to assist with heat dissipation through submount 14. In alternative embodiments, submount 14 can comprise a ceramic such as alumina, aluminum nitride, silicon, sapphire, silicon carbide, or a polymeric material such as polyamide, polyester, etc. As FIG. 2B illustrates and as described further below, component 15 can comprise LED chips 12 and lenses 16 attached over an intermediate submount 25. Intermediate submount 25 can then be attached to submount 14.

Submount 14 can comprise electrically conductive layers of material allowing LED chips 12 to electrically communicate with attachment surfaces 18 such that LED chips 12 illuminate when components 10 and 15 receives electrical signal or current from external electrical components such as electrically conductive wires (not shown). LED chip 12 can attach to submount 14 using suitable or known attachment materials and methods, for example, solder attachment, preform attachment, flux or no-flux eutectic attachment, silicone epoxy attachment, metal epoxy attachment, thermal compression attachment, and/or combinations thereof. One or more test points 19 can be located on a portion of submount 14 for testing the electrical and/or thermal properties of emitter components 10 and 15. For example, test point 19 can allow thermal properties of the component to be tested when probed with any suitable temperature sensor (not shown).

Still referring to FIGS. 1 through 3, at least one LED chip 12 can be disposed over submount 14 under a lens 16. Each lens 16 can comprise a lens base 20 that can, in a chip on board (CoB) configuration, be formed on and directly attached to one or more surfaces of submount 14. It is also possible that lens base 20 can be indirectly attached to submount 14 as described further herein. In addition, one or more than one LED chip 12 can be placed under each lens 16. In one aspect, each lens 16 can comprise a liquid curable silicone material, an epoxy material, or any encapsulant material such as a methyl or phenyl based encapsulant material. The lens material can be molded and cured using known processes. Lens 16 and lens base 20 can comprise any suitable shape for producing desired light output. For example, lens 16 can comprise a substantially domed shape having a substantially circular lens base 20 as illustrated, or in the alternative, lenses corresponding to any other shaped base, for example, lenses corresponding to substantially square, diamond, oval, symmetrical and/or asymmetrical lens bases 20 are contemplated.

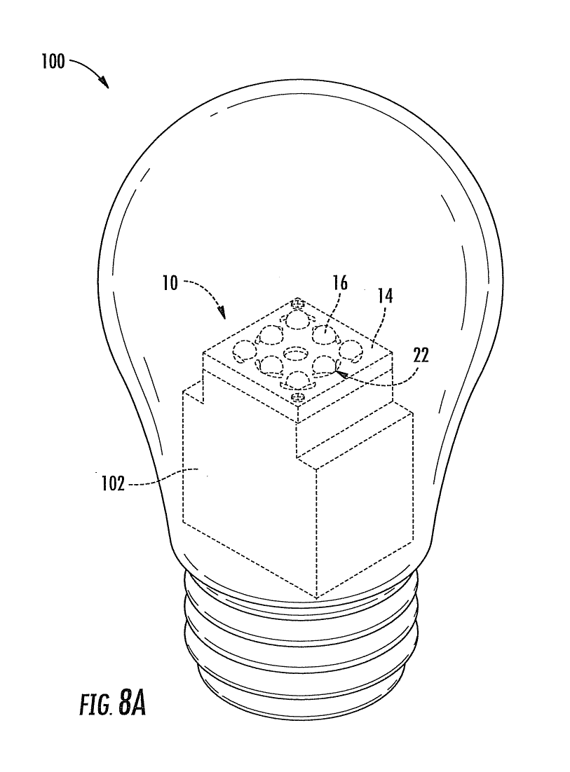

Lens 16 and lens base 20 can be formed directly and/or indirectly over a top surface of submount 14, and can be disposed over at least one LED chip 12. An array of lenses 16 can be molded and/or positioned over a corresponding array of LED chips 12. Lenses 16 can provide both environmental and/or mechanical protection of light emitter components 10 and 15. Notably, novel emitter components described herein can be associated with and in one aspect can incorporate novel lenses 16, as for example, each lens 16 can be associated with one or more novel optical elements generally designated 22. Optical elements 22 can in one aspect each be an extension portion extending from a lens 16, or each optical element 22 can be associated with a lens 16 without extending from or being attached to lens 16 as described further herein. Optical elements 22 can comprise an elongated portion or member that, for example and without limitation, can be either be formed integrally with each lens 16, formed and disposed separately from each lens 16, or even can be a combination of both. Optical elements 22 can for example comprise at least a first portion 24A and optionally a second portion 24B, as each portion can extend outwardly from lens 16 and along a portion of lens base 20. For illustration purposes, two such portions (e.g., first and second portions 24A and 24B) are illustrated in the optical elements 22 associated with each lens 16, however optical elements having more or less than two portions are also contemplated herein. For example, in one aspect optical elements 22 can comprise a single elongated portion having a single curved footprint as shown and described in FIG. 7.

First and second portions 24A and 24B can comprise substantially elongated members extending along portions of lens base 20 such that they directly touch portions of lens base 20 or such that they are separate and apart from lens base 20 or LED chips as described further herein. Each optical element 22 can be an elongated and concave structure or configuration adapted and configured for affecting and reflecting light in a desired manner as described further herein. An angle α can be disposed between first and second portions 24A and 24B, respectively. In one aspect, angle α can comprise an angle of approximately 45° or more, such as an angle of approximately 50° or more, approximately 60° or more, approximately 70° or more, or more than 80°. In other aspects, angle α can comprise an angle of approximately 90° or more, such as an angle of approximately 95° or more, approximately 100° or more, approximately 110° or more, approximately 120° or more, or more than 150°.

In addition, first and second portions 24A and 24B can extend beyond the areas where they touch lens base 20 such that one, more than one, or all of optical elements 22, in one aspect and without limitation, can be longer than a diameter of an associated lens such as lens 16. In other aspects, first and second portions 24A and 24B may not extend beyond the areas where they touch lens base 20 such that one, more than one, or all of optical elements 22, in one aspect and without limitation, can be shorter than a diameter of an associated lens such as lens 16. In one aspect, portions 24A and 24B of an optical element 22 can extend along submount 14 to a greater overall length than the length of each lens 16 (e.g., diameter of lens base 20). Optical element 22 can extend to a length L of approximately 1 millimeter (mm) or more, approximately 2 mm or more, approximately 4 mm or more, approximately 6 mm or more, approximately 8 mm or more, approximately 10 mm or more, or more than approximately 10 mm. In one aspect, optical element 22 can extend to a total length L of approximately 6.2 mm or 6.3 mm. As optical element 22 can comprise an elongated and curved member, length L can comprise a measurement of the actual distance between the ends of first and second portions 24A and 24B as shown, rather than the length of the entire curve. Lens 16 can comprise a substantially circular lens base 20 having a diameter of less than approximately 2 mm (e.g., 0.5 mm or 1 mm), approximately 2 mm or more, approximately 3 mm or more, approximately 4 mm or more, or more than approximately 5 mm. In one aspect, lens 16 comprises a diameter of approximately 4.5 mm. Any combination of length L and length of lens diameter (e.g., diameter of lens base 20) is contemplated herein.

First and second portions 24A and 24B can comprise substantially the same length as shown or, alternatively, one of the first and second portions 24A and 24B can be longer than the other. First and second portions 24A and 24B can comprise substantially symmetric members (i.e., symmetrically placed about lens 16) that can, but do not have to form a mirror image about lens 16. Asymmetric, non-mirror image arrangements of first and second portions 24A and 24B are also contemplated herein. Optical element 22 can be directly disposed adjacent lens 16 in an abutting position and can be oriented such that each optical element 22 is also disposed adjacent or proximate an edge of submount 14. In one aspect, each optical element 22 can be disposed between an LED chip 12 and the edge of submount 14.

Notably, first and second portions 24A and 24B of optical elements 22 can comprise substantially curved, convex, or concave portions which can curve slightly inwardly towards each other in a generally C-shaped configuration as shown or, alternatively, can curve in any direction or orientation for producing any desired light output. In one aspect, one or more optical element 22 can be tangentially aligned with respect to lens 16 such that it contacts lens base 20 at a point or at least a portion thereof. Optical element 22 can but does not have to contact lens base 20. In further embodiments, each optical element 22 can contact its associated and corresponding lens base 20 at more than one point or portion. First and second portions 24A and 24B can be offset by an angle θ from where optical element 22 tangentially contacts lens 16 or lens base 20. That is, first and second portions 24A and 24B can be angled with respect to the circular lens base. In one aspect, first and second portions 24A and 24B can be offset by an angle θ of approximately 2 degrees (°) or more from where optical element 22 tangentially contacts lens base 20. In other aspects, lens portions 24A and 24B can be offset by an angle θ of approximately 5° or more, approximately 10° or more, approximately 15° or more, approximately 25° or more, approximately 30° or more, approximately 45° or more, or more than 45° from where optical element 22 tangentially contacts lens base 20. In some aspects, optical element 22 can be offset by any angle θ up to and including approximately 90° from where optical element 22 tangentially contacts lens base 20.

Still referring to FIGS. 1 through 3, the one or more portions such as first and second portions 24A and 24B can be formed integrally with lens 16, for example, formed via a same mold and/or during the same molding step as lens 16. That is, the mold that forms domed lens 16 can be integrated with a mold or mold portion for forming optical element 22. In other aspects, first and second portions 24A and 24B can be formed separately (e.g., via a different mold and/or during a different molding step) than lens 16. In one aspect, each optical element can 22 can comprise the same material as lens 16, for example, a molded and optionally curable silicone material. In other aspects, each optical element 22 can comprise a different material than lens 16, for example, a glass or plastic material. Each lens 16 and optical element 22 can comprise an optically clear material. In other aspects, portions of lenses 16 and optical elements 22 can comprise a semi-transparent material, be coated or layered with one or more phosphors or lumiphors, and/or comprise an opaque material. As FIG. 3 illustrates, first and second portions 24A and 24B can comprise a substantially semicircular or curved cross-sectional shape and a rounded upper surface.

Optical elements 22 can individually and together advantageously improve light extraction, for example, by producing a round shaped beam pattern from a non-round array of LED chips, such as a CoB array or a non-CoB array, or by producing any desired shape of light beam pattern from an array of LED chips arranged in a configuration different from the desired beam pattern. As previously discussed, one drawback to conventional components is that square or non-round arrays of LED chips produce square or non-round beams of light. As die attach and wirebonding LED chips configured in square arrays can be more time efficient than producing arrays of other shapes, novel and simplified methods of producing a round beam pattern, for example, by using optical elements 22 can be advantageous. By incorporating novel optical elements 22 as shown and described herein, LED chips 12 configured or arranged in substantially square shaped or non-round arrays can advantageously improve light output by producing round shaped beam patterns suitable for light bulb or light fixture applications. For example, one or more optical elements 22 can be disposed over submount 14 to produce a virtually round shaped beam of light from a square shaped array of LED chips 12 by manipulating light emission to conform to a round shape. Other shapes of light beam patterns are possible also and other LED chip configurations are possible also as described further herein.

In one aspect, first and second portions 24A and 24B of optical elements 22 can manipulate the beam of light emitted by LED chips 12 by causing light to reflect from optical elements 22 such that the resulting light pattern conforms to the shape of the rounded portions 24A and 24B to collectively form a virtually round shaped beam between opposing optical elements 22. Notably, optical elements 22 enable a square shaped array of LED chips 12 to produce a round shaped beam pattern therebetween. Any desired shape of light beam pattern from an array of LED chips arranged in a configuration different from the desired beam pattern can be produced as optical elements 22 can be arranged about any shape of LED chip array for producing any desired shaped beam of light. Optical elements 22 can be arranged such that they are disposed outside of the LED chip array (i.e., along outer edges of the array of LED chips 12) between the LED chips 12 and outermost edges of submount 14.

FIG. 2B illustrates light emitter component 15 having more than one submount. At least one LED chip 12, lens 16, and optical element 22 can be disposed over an intermediate submount 25 in a CoB structure or CoB array. In one aspect, each LED chip 12, lens 16, and optical element 22 in an array of chips 12, lenses 16, and elements 22 can be disposed over a plurality of one or more intermediate submounts 25. The one or more intermediate submounts 25 can be spaced apart as illustrated to facilitate selective rotation about arrows A for selective alignment of optical element 22. Each intermediate submount 25 can comprise a single LED chip 12, a single lens 16, and a single optical element 22 or more than one LED chip 12, more than one lens 16 and more than one optical element 22. Intermediate submounts 25 can be spaced closer together than shown or further apart than shown.

Lenses 16 and optical elements can directly attach to intermediate submount 25 in the CoB array. Intermediate submount 25 can comprise any material, and can optionally be electrically and/or thermally conductive. In one aspect, intermediate submount 25 can comprise a metal, ceramic, polymeric, or composite material that can be either used alone and/or in used in combination with other materials. Intermediate submount 25 can comprise a single layer of material or more than one layer of material and/or a laminate structure consisting of layers of one or more metals, ceramics, dielectrics, and/or polymeric materials. Light emitter component 15 can comprise a single submount 14 having areas where one or more intermediate submounts 25 can be disposed between LED chips 12 and portions of the submount 14 in addition to areas where LED chips 12 are mounted to submount 14 as in component 10. In other aspects, component 15 can comprise a single submount 14 having a total of n intermediate submounts 25 disposed thereon, where n is equal to the number of LED chips 12. As a result, a total of n intermediate submounts 25 can be disposed between a total of n LED chips 12 and a single monolithic submount 14. In further aspects, a single monolithic intermediate submount 25 can have multiple LED chips 12 disposed thereon (e.g., an array of LED chips 12) and can in turn be disposed over a single monolithic submount 14. Any suitable configuration is contemplated herein.

In one aspect, intermediate submount 25 can comprise a monolithic submount disposed over submount 14. Intermediate submount 25 can attach or adhere to submount 14 via any suitable adhesive material or laminate. As indicated by the arrows A in FIG. 2B, one or more intermediate submounts 25 can be configured to rotate or adapt to any position over submount 14 such that optical elements 22 can be selectively positioned or configured in any desired orientation over submount 14. Where more than one intermediate submount 25 is used, the submounts 25 can comprise any shape. Each intermediate submount 25 can comprise the same shape, or submounts 25 can be different shapes. For illustration purposes intermediate submounts 25 that are substantially square shapes are illustrated, however; any other shape such as substantially circular, rectangular, symmetric, and/or asymmetric shapes are contemplated herein. Intermediate submounts 25 can, but do not have to be the same shape. For example, intermediate submounts 25 of different shapes can be used in combination over submount 14 within component 15.

Light emitter components 10 and 15 can further comprise at least one opening or hole generally designated 26, which can be disposed through or at least partially through submount 14 for facilitating attachment of the components to an external substrate or surface. For example, one or more attachment members such as screws can be inserted through the at least one hole 26 for securing light emitter components 10 and 15 to another member, structure, or substrate. In one aspect, one or more attachment members can secure light emitter components 10 and 15 to surfaces of a light bulb or light fixture application as shown in FIGS. 8A and 8B.

FIGS. 4A to 4H illustrate placement of various LED chips and shapes of LED chip arrays and subarrays over submount 14 for which optical elements 22 can be used to shape light. Beam shaping can thereby advantageously improve light extraction from light emitter components 10 and 15 by producing a desired configuration, such as a rounded beam, of light 30 substantially centrally disposed between opposing optical elements 22 thereby improving light extraction and emission from light emitter components 10 and 15 by making it more suitable for light bulb or fixture applications. In one aspect, light emitter components 10 and 15 can comprise optical elements 22 for producing any desired shape of light beam from any desired shape of LED chip array. For example, in FIG. 4A, the numbers 1 to 8 schematically illustrate the placement or arrangement of eight LED chips into a substantially square shaped array. Optical elements 22 (FIGS. 1 to 3) can be disposed about the array (i.e., between the LED chips and edges of submount 14) for producing a round shaped beam pattern or beam of light 30 from the substantially square shaped array by bending, curving, and/or reflecting light from portions of optical elements 22 which are offset by angles θ about portions of lens 16 (see, e.g., FIGS. 1 to 3). Beam pattern can also be affected by the angle α between first and second portions 24A and 24B (see, e.g., FIGS. 1 to 3). Angle α can be the same for each of the one or more optical elements 22 disposed about the array of LED chips, or at least a first angle α for a first optical element 22 of a plurality of optical elements can be different than at least a second angle α for a second optical element 22 of the plurality. The array of LED chips can be arranged over a square submount 14. However, any other shape of submount 14 is contemplated herein. For example, the broken lines 28 in FIG. 4A schematically illustrate a round submount, which also can be used herein.

FIG. 4B illustrates an arrangement of two LED chips. Numbers 1 and 2 correspond to two LED chips for which optical elements 22 (FIGS. 1 to 3) can be arranged about the LEDs and used to produce a substantially round shaped configuration or beam of light 30 from the non-rounded arrangement of LED chips. The arrows in FIGS. 4B, 4C, and 4E to 4G indicate possible locations, curvature, and/or positions for optical elements 22 portions of optical elements 22 (e.g., portions 24A and 24B). For example, in FIG. 4B, an optical element 22 (FIG. 1) could comprise portions extending in length along the arrows and/or become angled as indicated by the arrows to produce the round shaped beam of light 30 from the non-rounded arrangement of LED chips. Additionally, an optical element 22 (FIG. 1) could comprise portions that are curved as indicated by the arrows to produce the round shaped beam of light 30 from the non-rounded arrangement of LED chips. The portions (e.g., 24A and 24B, FIG. 1) of optical element 22 could be the same length or different lengths. The angle α between portions of optical element 22 (FIG. 1) about LED chip 1 could also be different than the angle α of an optical element positioned about LED chip 2.

FIG. 4C illustrates a triangular arrangement or array of LED chips. Numbers 1 to 3 correspond to three LED chips that can be arranged into a substantially triangular array of LEDs, for which optical elements 22 (FIGS. 1 to 3) can be arranged about the LEDs and used to produce a substantially round shaped beam of light 30 from the non-rounded array. As indicated by the arrows, optical elements 22 (FIG. 1) positioned about LEDs 2 and 3 could have longer portions in one direction (e.g., as indicated by the longer arrows) to provide the rounded light configuration or beam. FIG. 4D illustrates a square shaped array of at least four LED chips which can be arranged over submount 14 for which optical elements 22 (FIGS. 1 to 3) can be used to produce a round beam of light 30. Similarly, FIGS. 4E to 4H illustrate arrangements or arrays of five, six, and seven LED chips arranged in various non-round shapes over submount 14 from which optical elements 22 (FIGS. 1 to 3) can be used to produce a round configuration or beam of light 30. The various placements or arrangement of various LED chips within each of the arrays illustrated in FIGS. 4A to 4H indicates that different optical elements 22 (FIG. 1) positioned about different respective LED chips can comprise different angles α (i.e., not all angled the same) to produce a rounded beam from a non-rounded array, or to produce any other beam shape desired. For example, corner LED chips (e.g., LED 1 in FIG. 4E) can have an optical element 22 that is angled differently than another LED chip (e.g., LED 4 in FIG. 4E) to collectively produce a rounded beam of light, or any desired shape of light.

FIG. 4G illustrates two subarrays of LED chips, for example, a first subarray of LED chips corresponding to the numbers 1 to 3 and a second subarray of chips corresponding to the numbers 4 to 6. Each subarray can comprise a substantially triangular shape, the overall shape of LED chips 1 to 6 comprising a non-round elongated hexagonal shape. It is contemplated herein that optical elements 22 (FIGS. 1 to 3) can be used to produce a round beam of light 30 from any non-round shape or array of LED chips. Optical elements 22 (FIGS. 1 to 3) can be used to reflect light from one or more curved portions having curved surfaces thereby producing a round configuration or beam of light 30 from any symmetrically shaped array of LED chips and/or any non-symmetrical or asymmetrically shaped array of LED chips. As FIGS. 4A to 4H illustrate, LED chips can be arranged in a first shape or first array configuration and the beam of light 30 which is collectively output from the array LED chips can comprise a second shape or beam pattern, where the second shape or beam pattern is different than the first shape or first array configuration.

FIGS. 5A and 5B illustrate cross-sectional views of portions of a light emitter components as taken along the line 5A/5B-5A/5B in FIG. 1. FIG. 5A is a portion of a light emitter component, generally designated 40. Submount 14 can comprise a monolithic substrate having multiple internal layers or circuitry for carrying current through and dissipating heat from emitter components. In one aspect, submount 14 can comprise a core layer 42 that is electrically and/or thermally conductive, for example, a metal layer such as Cu or Al. Submount 14 can further comprise a dielectric layer 36 which can be electrically insulating but thermally conductive to assist with heat dissipation through submount 14. Submount 14 can further comprise an electrically conductive mounting surface 46 or layer over which one or more LED chips 12 can attach via known die attach processes and/or materials. In one aspect, mounting surface 46 comprises a layer or area of Cu, such as a Cu plated layer or a Cu foil layer. LED chip 12 can electrically communicate with an electrical trace 48. Electrical trace 48 can comprise a layer of Cu or Cu foil. Submount 14 can further and optionally comprise one or more layers of solder mask material 50 which can be white for reflecting light from component 40. In one aspect, LED chip 12 can electrically communicate with an exposed area of conductive trace 48 via a wirebond 52. Conductive mounting surface 46 and electrical trace 48 can electrically communicate with at least one attachment surface 18 (FIG. 1) and pass current from an external power source into LED chip 12 causing illumination thereof.

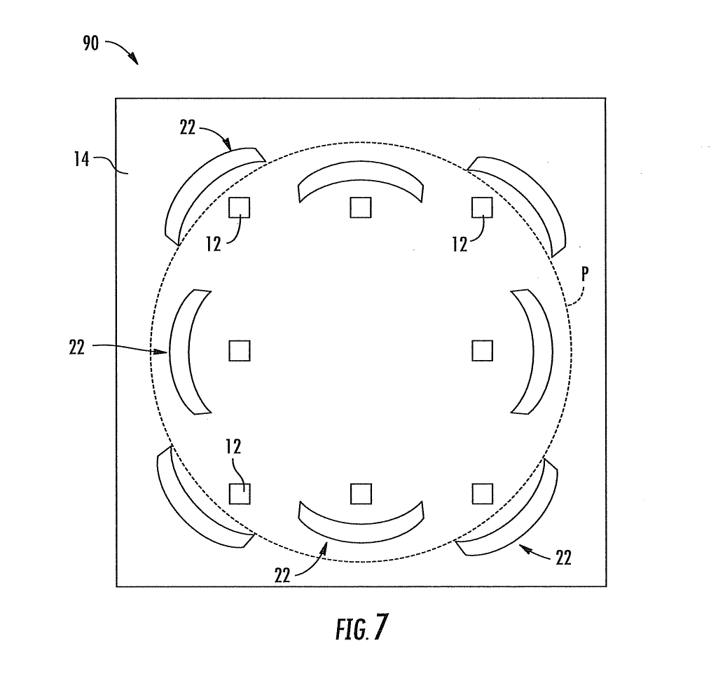

FIG. 5A further illustrates placement of LED chip 12 with respect to lens 16. For example and in one aspect, lens 16 can comprise a center line C which can essentially correspond to the center of the LED chip 12. Centerline C can be, but does not have to be the area of maximum height of lens 16. That is, lens 16 can comprise a cross-sectional shape other than a dome, and can have a height that is offset from the centerline C. Light extraction can be maximized when LED chip 12 is substantially centrally disposed under lens 16, however, as FIG. 6A illustrates, LED chip 12 can be offset from center line C and/or more than one chip 12 can be disposed below lens 16. As described earlier, lens 16 can comprise a lens base 20 which can directly attach to the submount such that LED chip 12 and lens 16 comprise a CoB structure. Lens 16 can comprise a substantially dome or hemispherical shape and can correspond to a circular lens base.

FIG. 5B illustrates a portion of a light emitter component generally designated 60. Component 60 can comprise an LED chip 62 having a horizontal build, in which the bottom portion of the LED chip 62 comprises both an anode and a cathode for electrically communicating with more than one conductive mounting surface 46. Together, the conductive mounting surfaces 46 can comprise an anode/cathode pair which can electrically communicate with respective anode/cathode attachment surfaces 18 (not shown, see FIG. 1). Electrical current can pass into component 60 from an outside power source (not shown) via attachment surfaces 18 (FIG. 1). Attachment surfaces 18 (FIG. 1) can electrically communicate with conductive mounting surfaces 46 along internal electrically conductive layers or paths disposed within submount 14.

FIG. 5B also illustrates placement of LED chip 62, which can be centrally disposed with respect to center line C of lens 16. For example, LED chip 12 can be disposed at different locations with respect to lens 16, such as approximately below a centerline C of lens 16 where lens 16 is of a maximum height. The center C of lens 16 can be, but does not have to be, the same as an apex, or point of maximum height of lens 16. Components described herein can comprise a plurality of optical lenses 16 where each of the lenses 16 overlies at least one LED chip 12 of an array of LED chips 12. There can be a total of n lenses 16, where n is equal to the number of LED chips 12 in the array. Alternatively, the number of lenses n may be less than the number of LED chips 12 in the array. For example, it is contemplated that one or more of the LED chips 12 may not underlie a lens 16. In this case, the number of lenses n is less than the number of LED chips 12. Also in this case, optical element 22 (FIG. 1) could be positioned between the uncovered LED chip 12 and an outermost edge of submount 14.

FIG. 6A illustrates a light emitter component 70 in which more than one LED chip 12 can be positioned below lens 16 as designated by the chips 12 in phantom lines. Where only one LED chip 12 is provided, that chip 12 can also be positioned below lens 16 in any of the orientations illustrated by the solid and phantom lines. For example, where only one LED chip 12 is encapsulated per dome or lens 16, the one LED chip 12 can be positioned off-center with respect to center line C as shown in phantom lines in order to shift the peak emission characteristics when desired. Emission pattern from a single LED chip 12 can also or further be shifted by location and/or angle of optical element 22 and first and second portions 24A and 24B of optical element 22. As described earlier, optical element 22 can be disposed between LED chip 12 and an outer edge of submount 14 such that the beam of light can be reflected inwardly towards a center of submount 14 for producing a round shaped beam of light suitable for a light bulb, light fixture, or other light product application.

As FIGS. 6A to 6C illustrate, optical element 22 can comprise a height H that is approximately equal to or greater than a thickness of LED chip 12. For illustration purposes, optical element 22 is illustrated as having a height H that is greater than the thickness of LED chip 12; however, height H can also substantially equal the chip thickness if desired. Optical element 22 having a height H can affect light output from LED chip 12 by generally shifting or reflecting light inwardly toward a center of submount 14 to help produce at least a substantially round or circular shaped beam pattern. Notably, light having a round shaped beam pattern can be produced from non-round arrays of LED chips 12. Additionally, light having any shape of beam pattern can be produced from any shape of LED chip array according to the components and lenses described herein. For example, the LED chip array can comprise a first shape and the beam of light can comprise a second shape, where the first and second shapes are not the same.

FIG. 6B illustrates another embodiment of a light emitter component, generally designated 80. In this embodiment, LED chip 12 can be disposed over a first submount 82 that does not extend below optical element 22. First submount 82 can comprise, for example, a body of an LED package such that the array of LED chips 12 is formed by discrete LED packages rather than CoB structures. In one embodiment, LED chip 12 can be mounted to first submount 82, which in turn can be mounted to submount 14 such that LED chip 12 is indirectly provided over submount 14. In one aspect, first submount 82 can comprise any suitable material, and can be electrically and/or thermally conductive or non-conductive. In one aspect, first submount 82 can comprise a plastic body with internal heat sink and electrical members for physically, electrically, and thermally communicating to a portion of submount 14. In other aspects, first submount 82 can comprise a ceramic material such as a low temperature co-fired ceramic (LTCC) material, a high temperature co-fired ceramic (HTCC) material, alumina, aluminum nitride (AlN), aluminum oxide (Al₂O₃), glass, and/or an Al panel material. In other aspects, first submount 82 can comprise a plastic material such as polyimide (PI), polyamide (PA), polyphthalamide (PPA), liquid crystal polymer (LCP), or silicone. First submount 82 can comprise any suitable size and/or shape, for example, a substantially square, rectangular, circular, oval, regular, irregular, or asymmetrical shape. LED chip 12 can be die attached using any suitable material and/or technique (e.g., solder attachment, preform attachment, flux or no-flux eutectic attachment, silicone epoxy attachment, metal epoxy attachment, thermal compression attachment, and/or combinations thereof) for directly electrically connect LED chip 12 within package.

FIG. 6C illustrates another embodiment of a light emitter component 85. As FIG. 6C illustrates, LED chip 12, lens 16, and optical element 22 can each be disposed over intermediate submount 25 as previously shown and described in FIG. 2B. In one aspect, lens 16 can directly attach to intermediate submount 25 in a CoB array. Intermediate submount 25 can comprise any electrically and/or thermally conductive material. Intermediate submount 25 can also comprise a thermally or electrically non-conductive material as well. Intermediate submounts 25 can allow for selective positioning of one or more of the optical elements 22 to result in a desired light beam pattern or shape.

FIG. 7 is a schematic illustration of a light emitter component generally designated 90. In this embodiment, the location of optical elements 22 with respect to a centrally disposed and rounded shaped beam pattern P indicated in broken lines can be discerned more clearly, as the lenses 16 have been removed such that “footprints” of optical elements 22 can be seen. Optical elements 22 can be used apart from and/or without lens 16 as shown. As indicated, the curvature of optical elements 22 can project or reflect light from LED chips 12 inwardly towards the center of submount 14 thereby producing the substantially circular or rounded beam pattern P which is suitable for light bulb and/or light fixture applications. It is contemplated that optical elements 22 can also be arranged such that beam patterns can be produced over submount 14 in areas that are off-center or non-centrally disposed such as producing light from edges, corner, or sides of component 90. As FIG. 7 indicates, the round shaped beam pattern P can be produced from a substantially square shaped array of lenses 16 (not shown) comprising optical elements 22 extending therefrom. Optical elements 22 can extend directly from lenses 16 (not shown) and/or be spaced apart from lenses 16 (shown in previous drawings). Where optical elements 22 are spaced apart from the lenses 16, optical elements 22 can be disposed between respective lenses 16 and the outermost edges of submount 14 as well as between respective LED chips 12 (not shown) and outermost edges of submount 14.

Components described herein can comprise any suitable size. In one aspect, submount 14 can comprise a square having each side measuring approximately 50 mm or less. In other aspects, submount 14 can comprise a square having each side measuring approximately 25 mm or less. In further aspects, submount 14 can comprise a square having each side measuring approximately 10 mm or less. Rectangular and circular submounts 14 are also contemplated herein. Submount 14 can comprise any suitable thickness, for example, submount 14 can comprise a thickness of approximately 5 mm or less, approximately 1 mm or less, or less than approximately 1 mm. The array of LED chips 12 can comprise LED chips 12 that are spaced apart at any period, for example, LED chips 12 can be approximately 20 mm apart or less, approximately 10 mm apart or less, approximately 7 mm apart or less, approximately 5 mm apart or less, or less than 5 mm apart and can depend upon the size of the LED chips.

FIGS. 8A and 8B illustrate lighting products capable of incorporating light emitter components 10, 15, and any other embodiments as shown and described herein. Any number of lighting applications and products is contemplated; for illustration purposes only and without limitation, a light bulb, generally designated 100 and a lighting fixture, generally designated 110 are shown. As FIG. 8A illustrates in phantom lines, light emitter component 10 can be incorporated within an LED light bulb 100. For example, submount 14 can be disposed over a holding member 102 or heat sink member within bulb 100. In one aspect, submount 14 can be fastened or screwed into holding member 102. As previously described, emitter component 10 can comprise an array of one or more LED chips 12 arranged in a square array (FIG. 1) over submount 14. Each LED chip 12 (FIG. 1) can be disposed under a lens 16 having a lens base 20 (FIG. 1) that is directly attached and disposed over submount 14 in a CoB configuration. LED chips 12 (FIG. 1) arranged in a square array, for example, can advantageously minimize die attach and wirebonding steps, however, conventional beam patterns emitted from square arrays are not optimized for light bulb applications. Notably, components comprising novel optical elements 22 described herein can produce a predetermined beam pattern, such as a round beam pattern of light which can be more suitable for some lighting applications and can advantageously improve light emission from LED light devices such as from light bulb 100.

Similarly, FIG. 8B illustrates a lighting fixture 110 incorporating light emitter component 10. Lighting fixture 110 can comprise a downlight or “can” light used in personal, commercial, and industrial lighting applications. Light emitter component 10 can be disposed over a mounting substrate or surface 112 and can advantageously produce an improved, round shaped beam pattern of light via one or more optical elements 22 disposed outside a non-round array of LED chips 12 (FIG. 1) disposed below respective lenses 16.

Embodiments of the present disclosure shown in the drawings and described above are exemplary of numerous embodiments that can be made within the scope of the appended claims. It is contemplated that the novel light emitter components having improved light extraction and methods of making the same can comprise numerous configurations other than those specifically disclosed. It is also contemplated that the novel lenses disclosed herein for providing improved light extraction and desired beam patterns can also comprise numerous configurations other than those specifically described.

What is claimed is:

1. A light emitter component comprising:
a submount;
at least one light emitting chip disposed over the submount;
a lens disposed over the at least one light emitting chip; and
an optical element associated with the lens wherein the optical element is configured to affect light output from the light emitting chip.

2. The light emitter component of according to claim 1, wherein the optical element is elongated and comprises a length that is greater than a diameter of the lens.

3. The light emitter component according to claim 1, wherein the optical element comprises a length of approximately 4 millimeters (mm) or more.

4. The light emitter component according to claim 1, wherein the optical element comprises a length of approximately 6 millimeters (mm) or more.

5. The light emitter component according to claim 1, wherein the optical element comprises a first elongated portion and a second elongated portion.

6. The light emitter component according to claim 5, wherein the first elongated portion and the second elongated portion curve inwardly towards each other.

7. The light emitter component according to claim 6, wherein an angle of approximately 90° or more exists between the first and second elongated portions.

8. The light emitter component according to claim 7, wherein an angle of approximately 100° or more exists between the first and second elongated portions.

9. The light emitter component according to claim 7, wherein an angle of approximately 120° or more exists between the first and second elongated portions.

10. The light emitter component according to claim 1, wherein the optical element contacts at least a portion of the lens.

11. The light emitter component according to claim 1, wherein the optical element comprises a molded silicone material.

12. The light emitter component according to claim 1, wherein the optical element comprises a plastic material.

13. The light emitter component according to claim 1, wherein the at least one light emitting chip comprises at least one light emitting diode (LED) chip.

14. The light emitter component according to claim 13, wherein the optical element comprises a height that is greater than a thickness of the at least one LED chip.

15. The light emitter component according to claim 14, wherein the at least one LED chip comprises an array of LED chips.

16. The light emitter component according to claim 15, wherein the array of LED chips comprises a non-round shaped array of LED chips.

17. The light emitter component according to claim 16, wherein the array of LED chips comprises a square shaped array of LED chips.

18. The light emitter component according to claim 17, comprising a plurality of optical elements and wherein the optical elements are configured to affect light output from the square shaped array of LED chips to produce a round shaped beam pattern of light.

19. The light emitter component according to claim 1 wherein the light emitting chip is mounted to the submount in a chip on board (CoB) configuration.

20. The light emitter component according to claim 1 wherein the light emitting chip is mounted indirectly to the submount.

21. A light bulb incorporating the light emitter component according to claim 1.

22. A light fixture incorporating the light emitter component according to claim 1.

23. A method of providing a light emitter component, the method comprising:
providing a submount;
attaching at least one light emitting chip to a surface of the submount;
providing a lens over the at least one light emitting chip; and
providing an optical element configured to affect light output from the light emitting chip.

24. The method according to claim 23, comprising providing an elongated optical element with a length that is greater than a diameter of the lens.

25. The method according to claim 23, comprising providing the optical element with a length of approximately 4 millimeters (mm) or more.

26. The method according to claim 23, wherein the optical element contacts at least a portion of the lens.

27. The method according to claim 23, wherein the optical element has a first elongated portion and a second elongated portion.

28. The method according to claim 27, comprising providing the optical element wherein the first elongated portion is at an angle with respect to the second curved portion.

29. The method according to claim 28, wherein the angle is approximately 90° or more.

30. The method according to claim 28, wherein the angle is approximately 100° or more.

31. The method according to claim 28, wherein the angle is approximately 120° or more.

32. The method according to claim 23, wherein providing the lens comprises molding the lens and the optical element from a liquid curable silicone material, epoxy material, or encapsulant material.

33. The method according to claim 23, wherein providing the at least one light emitting chip comprises providing at least one light emitting diode (LED) chip.

34. The method according to claim 33, comprising providing the optical element with a height that is greater than a thickness of the at least one LED chip.

35. The method according to claim 33, wherein providing at least one LED chip comprises providing an array of LED chips.

36. The method according to claim 35, wherein providing the array of LED chips comprises a providing a non-round shaped array of LED chips.

37. The method according to claim 36, wherein providing the array of LED chips comprises a providing a square shaped array of LED chips.

38. The method according to claim 37, further comprising a plurality of the optical elements and producing an at least substantially round shaped beam pattern of light from the square shaped array of LED chips by reflecting light emitted by the LED chips from the plurality of optical elements.

39. A lens comprising:
a lens base comprising a diameter;
an elongated optical element extending from the lens base; and
the elongated optical element having a length that is greater than the diameter of the lens base.

40. The lens according to claim 39, wherein the length of the optical element is approximately 4 millimeters (mm) or more.

41. The lens according to claim 39, wherein the length of the optical element is approximately 6 millimeters (mm) or more.

42. The lens according to claim 39, wherein the optical element comprises a first elongated portion and a second elongated portion.

43. The lens according to claim 42, wherein the first elongated portion and the second elongated portion curve inwardly towards each other.

44. The lens according to claim 42, wherein an angle of approximately 90° or more exists between the first and second elongated portions.

45. The lens according to claim 39, wherein the optical element comprises a molded silicone material.

46. The lens according to claim 39, wherein the optical element comprises a plastic material.

47. A light emitter component comprising the lens according to claim 39, wherein the lens is disposed over at least one light emitting diode (LED) chip.

48. The light emitter component according to claim 47, wherein the optical element comprises a height that is greater than a thickness of the at least one LED chip.

49. A light emitter component comprising:
a submount;
an array of light emitting chips disposed over the submount, the array being arranged in a first array configuration;
lenses disposed over the light emitting chips; and
optical elements associated with the lenses and configured to affect light output from the light emitting chips to emit a light beam pattern in a shape different from the first array configuration.

50. The light emitter component according to claim 49, wherein the first array configuration is non-round.

51. The light emitter component according to claim 50, wherein the light beam pattern is substantially rounded.

52. The light emitter component according to claim 49, wherein each of the optical elements comprise first and second portions.

53. The light emitter component according to claim 52, wherein the first portion is angled with respect to the second portion.

54. The light emitter component according to claim 49, wherein the optical elements are elongated and curved.

55. The light emitter component according to claim 49, wherein the optical elements are disposed over an intermediate submount for selective positioning of the optical elements.

56. A method for producing a desired light beam pattern from a light emitter component, the method comprising:
providing a light emitter component comprising:
a submount;
an array of light emitting chips disposed over the submount, the array being arranged in a first array configuration;
lenses disposed over the light emitting chips; and
optical elements associated with the lenses; and
emitting light from the array of light emitting chips in a light beam pattern that is different from the first array configuration.

57. The method of claim 56, comprising selectively positioning one or more of the optical elements to result in the light beam pattern.

58. The method of claim 56, wherein the first array configuration is substantially square and the light beam pattern is substantially round.
